(19) United States
(12) Patent Application Publication
(10) Pub. No.: US 2004/0000887 A1
(43) Pub. Date: Jan. 1, 2004

(54) Method and apparatus for controlling a motor of a hybrid electric vehicle

(76) Inventor: Han-Seung Lim, Paju-City (KR)

Correspondence Address: Pennie & Edmonds, LLP, 3300 Hillview Avenue, Palo Alto, CA, 94304, US

(21) Appl. No.: 10/321,092

(22) Filed: Dec. 16, 2002

(30) Foreign Application Priority Data
Jun. 29, 2002 (KR) 2002-0037451

(51) Int. Cl. H02P 7/00

(52) U.S. Cl. 318/432

(57) ABSTRACT

An apparatus for controlling a motor of a hybrid electric vehicle comprises a motor control unit and an electric control unit. The motor control unit is for controlling the motor under the control of the electric control unit. The electric control unit is for calculating a motor torque based on accelerator pedal position and a change thereof. The electric control unit also executes predetermined software. The software comprises instructions for: determining an accelerator pedal position and a change thereof; calculating a motor torque based on the accelerator pedal position; low-pass filtering the motor torque based on a filtering constant selected from a plurality of predetermined constants; and, controlling the motor based on the low-pass filtered motor torque.

### FIELD OF THE INVENTION

The present invention relates to a hybrid electric vehicle, and more particularly, to a method and apparatus for controlling a motor of a parallel-type hybrid electric vehicle that reduces an impulse from torque change of the motor caused by accelerator pedal operation.

### BACKGROUND OF THE INVENTION

In a hybrid electric vehicle (HEV), the controller that controls the overall functions of electric components in the HEV is usually called a hybrid vehicle control unit (HCU). The HCU typically controls several subsidiary controllers, including a motor control unit (MCU), an engine control unit (ECU), a battery management system (BMS), and a transmission control unit (TCU).

The MCU controls functioning of a motor of the HEV, such as driving torque, rotating speed, and electricity-generating torque. The ECU controls operation of an engine adopted for the HEV. The BMS detects parameters such as temperature, voltage, current, and state of charge (SOC) of a battery, and controls overall functioning of the battery. The state of charge is used by the HCU to control torque and speed of the motor. Finally, the TCU controls the transmission according to a preferred shift-speed determination based on vehicle-driving circumstances, such as vehicle speed and accelerator pedal operation.

The HCU and its subsidiary controllers communicate with one another utilizing a CAN (Controller Area Network) communication configuration.

One particular control function of the HCU is to control the ECU in order to provide an “idle stop and go” function that stops the engine when a predetermined condition occurs, and then restarts the engine when the predetermined condition ends. As is well-known in the art, the motor used in the HEV can function as both a driving power source and as a generator. The MCU controls functions of the motor, under the control of the HCU.

For example, for a motor having the specifications shown in Table 1, operation of the motor can be controlled in the manner shown in Table 2.

TABLE 1

| | | |
|---|---|---|
| Rated power for one minute use | 12 | KW |
| Rated power for continuous use | 6 | KW |
| Base Speed | 1,550 | RPM |
| Positive power range | 1,550˜4,000 | RPM |
| Maximum speed | 6,000 | RPM |

TABLE 2

| | | Motor functions as: | |
|---|---|---|---|
| | | Drive | |
| Throttle | | power | |
| position | Conditions | source | Generator |
| OFF | Throttle opening < 1.2% | Disabled | Enabled |
| Normal | 1.2% ≦ Throttle opening ≦ | Enabled | Disabled |
| | 95% | | |
| WOT (Wide | Throttle opening > 95% | Enabled | Disabled |
| Open Throttle) | | | |

Thus, output torque and functioning of the motor in an HEV depends on throttle opening, corresponding to the degree of accelerator pedal operation and vehicle speed. Therefore, when the accelerator pedal operation abruptly changes from tip-in (i.e., accelerator is depressed) to tip-out (i.e., accelerator is released from being depressed), output torque of the motor accordingly changes abruptly, which causes a shock or abrupt change in the momentum of the vehicle, reducing passenger comfort.

In order to reduce this type of torque shock, the target motor torque can be low-pass filtered at the end of its calculation. However, this usually results in decreased motor output power. Thus it would be desirable to reduce the effects of abrupt torque change without substantially decreasing motor output power.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

In accordance with a preferred embodiment of the present invention, an exemplary motor control apparatus includes a motor control unit and an electric control unit. The motor control unit is for controlling the motor under the control of the electric control unit. The electric control unit is for calculating a motor torque based on accelerator pedal position and a change thereof, and also executes predetermined software.

The predetermined software comprises instructions for detecting an accelerator pedal position and a change thereof, calculating a motor torque based on the accelerator pedal position, low-pass filtering the motor torque based on a filtering constant selected from a plurality of predetermined constants, and controlling the motor based on the low-pass filtered motor torque.

Preferably, the instructions for low-pass filtering further include instructions for selecting the filtering constant based at least in part on the accelerator pedal position and the change thereof.

In another preferred embodiment, the instructions for low-pass filtering further include instructions for determining, based on the accelerator pedal position, whether an electricity-generating condition of the motor is satisfied, and instructions for selecting the filtering constant based at least in part on whether the electricity-generating condition of the motor is satisfied.

In a further preferred embodiment, the low-pass filtering instructions further comprise instructions for determining, when the electricity-generating condition of the motor is not satisfied, whether accelerator pedal operation is in a tip-in operation or a tip-out operation, and instructions for selecting the filtering constant based at least in part on whether the accelerator pedal operation is in tip-in operation or tip-out operation.

In other preferred embodiments of the present invention, the functionality of the apparatus for controlling a motor of a hybrid electric vehicle described above is implemented as methods for controlling a motor of a hybrid electric vehicle.

In yet another preferred embodiment of the present invention, a method for controlling a motor of a hybrid electric vehicle comprises determining a state of the motor selected from increasing drive torque, decreasing drive torque, and electricity generation. The method further comprises selecting a filtering constant from a plurality of predetermined constants based at least in part on the state of the motor, and low-pass filtering a drive torque applied to the motor based on the selected filtering constant. Additionally, the method comprises controlling the motor based on the low-pass filtered motor torque.

### BRIEF DESCRIPTION OF THE DRAWINGS

The accompanying drawings, which are incorporated in and constitute a part of the specification, illustrate preferred embodiments of the invention, and, together with the description, serve to explain the principles of the invention:

FIG. 1 is a block diagram of a motor control apparatus for a hybrid electric vehicle according to a preferred embodiment of the present invention;

FIG. 2 is a flowchart showing a motor control method for a hybrid electric vehicle according to another preferred embodiment of the present invention; and

FIG. 3 is a detailed flowchart showing a step for selecting an appropriate filtering constant for the motor control method for a hybrid electric vehicle of FIG. 2.

### DETAILED DESCRIPTION OF THE PREFERRED EMBODIMENTS

A preferred embodiment of the present invention will hereinafter be described in detail with reference to the accompanying drawings.

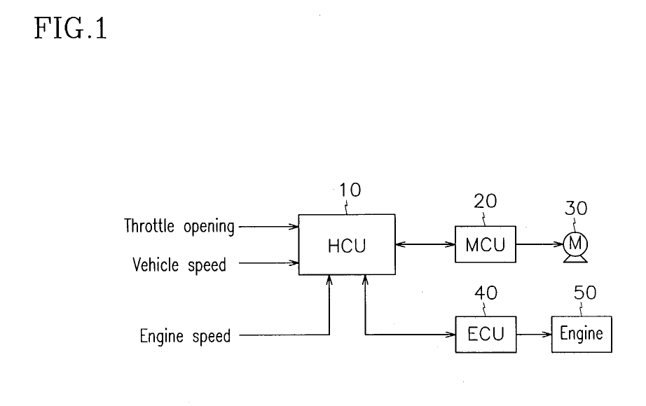

As shown in FIG. 1, a motor control apparatus according to a preferred embodiment of the present invention includes a hybrid vehicle control unit (HCU) 10, a motor control unit (MCU) 20, and an engine control unit (ECU) 40. Each control unit may comprise a processor and associated hardware and software as may be selected by a person of ordinary skill in the art based on the teachings herein.

The MCU 20 controls a motor 30 of the hybrid electric vehicle, operating either as a driving power source or an electricity generator, by controlling torque and speed, or electricity-generating torque, respectively. The ECU 40 controls an engine 50 of the vehicle, performing ignition control and idle-stop control of the engine. The HCU 10 calculates required motor torque based on vehicle speed and throttle opening, and controls the MCU 20 such that the required motor torque is achieved at the motor 30. The HCU 10 communicates with the MCU 20 and ECU 40 through a CAN communication configuration.

The HCU 10 utilizes a low-pass filter to execute low-pass filtering of motor torque, which is a sum of electricity-generating torque and driving torque of the motor 30, each of which is calculated based on the throttle opening and vehicle speed. In accordance with a preferred embodiment of the present invention, a variety of filtering constants can be utilized with the low-pass filtering of the motor torque. For example, the filtering constants may include a first predetermined value for reflecting tip-in operation of the accelerator pedal, such that the motor torque rapidly increases, and a second predetermined value for reflecting tip-out operation of the accelerator pedal, such that the motor torque slowly decreases.

An additional filtering constant is used when the motor 30 is functioning as an electricity generator. When this occurs, the filtering constants may include a third predetermined value that does not allow abrupt negative torque of the motor 30, in the event that accelerator pedal operation abruptly changes from tip-in operation.

Exemplary values for the first, second, and third predetermined values are shown in Table 3.

TABLE 3

| | Driving power source | | |
|---|---|---|---|
| | Torque increasing | Torque decreasing | Electricity |
| Motor operation | (tip-in) | (tip-out) | generator |
| Filtering | 5.0 | 0.5 | 3.0 |
| constant | | | |

The invention is not meant to be limited to the specific values shown in Table 3, because preferable values will depend on the specifications of a particular hybrid electric vehicle, and are meant to be more specifically adapted by a person skilled in the art.

As described above, the HCU 10 can be implemented as one or more processors that execute predetermined software, and the predetermined software can be programmed to perform each step of a motor control method according to a preferred embodiment of this invention. The low-pass filter can be implemented with either hardware components or by software, as is well-known in the art.

Operation of the motor control apparatus of the preferred embodiment of the present invention will now be described.

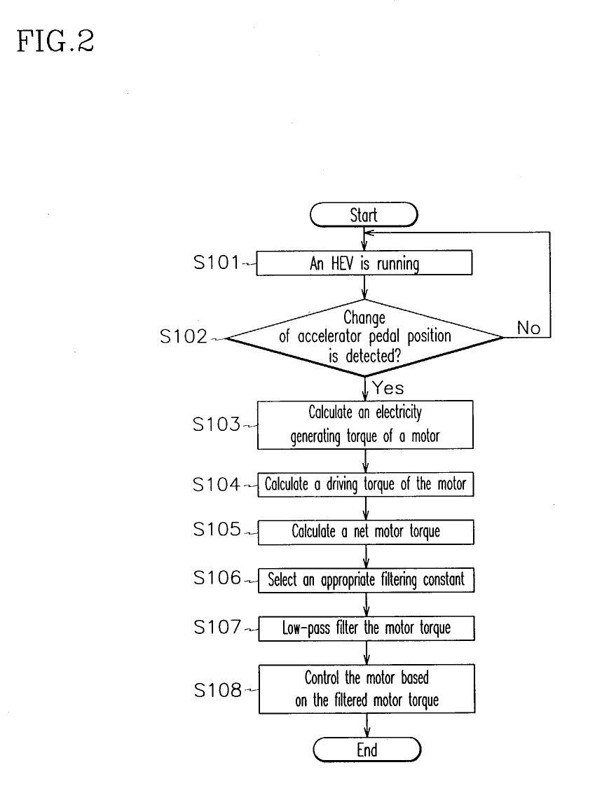

Referring to FIG. 2, when the hybrid electric vehicle is running (S101), the HCU 10 determines, by detecting the throttle opening, whether the accelerator pedal position has changed (S102). When a change of the accelerator pedal position is detected, the HCU calculates an electricity-generating torque (S103) and a driving torque (S104) of the motor 30. The electricity-generating torque and the driving torque of the motor are calculated in a conventional way.

The electricity-generating torque is a torque caused by generating electricity due to movement by the HEV, and the driving torque is a torque that is applied to drive the wheels in order to drive the HEV. Therefore, the value of the electricity-generating torque is a negative value relative to the value of the driving torque.

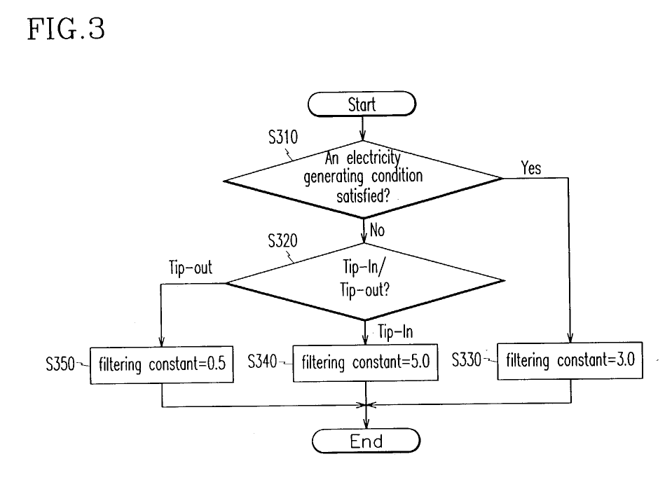

Subsequently, the HCU calculates a net motor torque by summing the electricity-generating torque and the driving torque of the motor (S105). When the motor torque is calculated, the HCU then selects a specific filtering constant from among the first, second, and third predetermined constants (S106). The step of selecting a filtering constant is described in further detail hereinafter with reference to FIG. 3.

Referring to FIG. 3, the HCU determines if an electricity-generating condition is satisfied (S310), based on the throttle opening. Examples of different electricity-generating conditions are shown in Table 2 above. When the electricity-generating condition is satisfied, the value of the filtering constant is chosen as, e.g., 3.0 according to Table 3 (S320). When the electricity generating condition is not satisfied, however, the HCU further determines whether the accelerator pedal operation is in a Tip-In state or a Tip-Out state (S330). When the change of the throttle opening is positive, that is, when the accelerator pedal is depressed further, the HCU determines that the accelerator pedal operation is in a Tip-In state; otherwise, the HCU determines the accelerator pedal operation is in a Tip-Out state.

The filtering constant is chosen to be different values based oh whether the accelerator pedal operation is in Tip-In or Tip-Out states. For example, (and in accordance with Table 3), the value of the filtering constant is chosen as 5.0 when accelerator pedal operation is in Tip-In state (S340), and the value of the filtering constant is chosen as 0.5 when it is in Tip-Out state (S350).

Referring back to FIG. 2, when the value of the filtering constant is selected (S106), the HCU 10 performs low-pass filtering of the motor torque based on the selected filtering constant (S107). When the motor torque is low-pass filtered, the HCU controls the MCU 20 based on the filtered motor torque (S108), and accordingly the MCU controls the motor 30 based on the filtered motor torque.

In this manner, vibration and torque-shock of an HEV is reduced when operation of throttle valve is successively changed from among Tip-In and Tip-Out states in driving mode, and in electricity-generating mode, of the motor 30. Furthermore, prompt response to a driver's request for acceleration is achieved because a sufficiently large filtering constant can be set as a filtering constant for Tip-In operation.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A method for controlling a motor of a hybrid electric vehicle comprising:
detecting an accelerator pedal position and a change thereof;
calculating a motor torque based on the accelerator pedal position;
low-pass filtering the motor torque based on a filtering constant selected from a plurality of predetermined constants; and
controlling the motor based on-the low-pass filtered motor torque.

2. The method of claim 1, wherein the filtering constant is selected based at least in part on the accelerator pedal position and the change thereof

3. The method of claim 1, wherein:
the low-pass filtering the motor torque comprises determining, based on the accelerator pedal position, whether an electricity-generating condition of the motor is satisfied; and
the filtering constant is selected based at least in part on whether the electricity-generating condition of the motor is satisfied.

4. The method of claim 3, wherein:
the low-pass filtering the motor torque further comprises determining, when the electricity-generating condition of the motor is not satisfied, whether accelerator pedal operation is in a tip-in operation or a tip-out operation; and
the filtering constant is selected based at least in part on whether the accelerator pedal operation is in tip-in operation or tip-out operation.

5. An apparatus for controlling a motor of a hybrid electric vehicle comprising:
an electric control unit for calculating a motor torque based on accelerator pedal position and a change thereof; and
a motor control unit for controlling the motor under the control of the electric control unit;
wherein the electric control unit executes predetermined software, the predetermined software comprising instructions for:
detecting an accelerator pedal position and a change thereof;
calculating a motor torque based on the accelerator pedal position;
low-pass filtering the motor torque based on a filtering constant selected from a plurality of predetermined constants; and
controlling the motor based on the low-pass filtered motor torque.

6. The apparatus of claim 5, wherein the instructions for low-pass filtering further include instructions for selecting the filtering constant based at least in part on the accelerator pedal position and the change thereof.

7. The apparatus of claim 5, wherein the instructions for low-pass filtering further comprise:
instructions for determining, based on the accelerator pedal position, whether an electricity-generating condition of the motor is satisfied; and
instructions for selecting the filtering constant based at least in part on whether the electricity-generating condition of the motor is satisfied.

8. The apparatus of claim 7, wherein the instructions for low-pass filtering further comprise:
instructions for determining, when the electricity-generating condition of the motor is not satisfied, whether accelerator pedal operation is in a tip-in operation or a tip-out operation; and
instructions for selecting the filtering constant based at least in part on whether the accelerator pedal operation is in tip-in operation or tip-out operation.

9. A method for controlling a motor of a hybrid electric vehicle comprising:
determining a state of the motor selected from increasing drive torque, decreasing drive torque, and electricity generation;
selecting a filtering constant from a plurality of predetermined constants based at least in part on the state of the motor;
low-pass filtering a drive torque applied to the motor based on the selected filtering constant; and
controlling the motor based on the low-pass filtered motor torque.
